(19) United States
(12) Patent Application Publication
(10) Pub. No.: US 2012/0140097 A1
(43) Pub. Date: Jun. 7, 2012

(54) METHOD AND APPARATUS FOR IMAGE CAPTURING CAPABLE OF EFFECTIVELY REPRODUCING QUALITY IMAGE AND ELECTRONIC APPARATUS USING THE SAME

(76) Inventors: Nobuhiro Morita, Kanagawa-ken (JP); Yuji Yamanaka, Kanagawa-ken (JP); Nobuo Sakuma, Tokyo (JP)

(21) Appl. No.: 13/094,849

(22) Filed: Apr. 27, 2011

Related U.S. Application Data
(62) Division of application No. 11/798,472, filed on May 14, 2007, now abandoned.

(30) Foreign Application Priority Data
May 15, 2006 (JP) 2006-135699

(51) Int. Cl. H04N 5/217

(52) U.S. Cl. 348/241; 348/E05.078

(57) ABSTRACT

An image capturing apparatus includes an imaging lens, an image pickup device, and a correcting circuit. The imaging lens is configured to focus light from an object to form an image. The image pickup device is configured to pick up the image formed by the imaging lens. The correcting circuit is configured to execute computations for correcting image degradation of the image caused by the imaging lens. The imaging lens is also a single lens having a finite gain of optical transfer function and exhibiting a minute difference in the gain between different angles of view of the imaging lens.

### PRIORITY STATEMENT

The present patent application claims priority Under 35 U.S.C. §119 to Japanese patent application No. JP2006-135699 filed on May 15, 2006, in the Japan Patent Office, the entire contents of which are hereby incorporated by reference.

### FIELD OF THE INVENTION

The present patent specification relates to a method and apparatus for image capturing and an electronic apparatus using the same, and more particularly to a method and apparatus for image capture and effective generation of a high quality image and an electronic apparatus using the same.

### BACKGROUND OF THE INVENTION

Image capturing apparatuses include digital cameras, monitoring cameras, vehicle-mounted cameras, etc. Some image capturing apparatuses are used in image reading apparatuses or image recognition apparatuses for performing iris or face authentication. Further, some image capturing apparatuses are also used in electronic apparatuses such as computers or cellular phones.

Some image capturing apparatuses are provided with an imaging optical system and an image pickup device. The imaging optical system includes an imaging lens that focuses light from an object to form an image. The image pickup device, such as a CCD (charge coupled device) or CMOS (complementary metal-oxide semiconductor) sensor, picks up the image formed by the imaging lens.

For such image capturing apparatuses, how to effectively reproduce a high quality image is a challenging task. Generally, image capturing apparatuses attempt to increase the image quality of a reproduced image by enhancing the optical performance of the imaging optical system.

However, such a high optical performance is not so easily achieved in an imaging optical system having a simple configuration. For example, an imaging optical system using a single lens may not obtain a relatively high optical performance even if the surface of the single lens is aspherically shaped.

Some image capturing apparatuses also attempt to increase the image quality of a reproduced image by using OTF (optical transfer function) data of an imaging optical system.

An image capturing apparatus using the OTF data includes an aspheric element in the imaging optical system. The aspheric element imposes a phase modulation on light passing through an imaging lens. Thereby, the aspheric element modulates the OTF to suppress the change of OTF depending on the angle of view or distance of the imaging lens from the object.

The image capturing apparatus picks up a phase-modulated image by an image pickup device and executes digital filtering on the picked image. Further, the image capturing apparatus restores the original OTF to reproduce an object image. Thus, the reproduced object image may be obtained while suppressing a degradation caused by differences in the angle of view or the object distance.

However, the aspheric element has a special surface shape and thus may unfavorably increase manufacturing costs. Further, the image capturing apparatus may need a relatively long optical path in order to dispose the aspheric element on the optical path of the imaging lens system. Therefore, an image capturing apparatus using an aspheric element is not advantageous in cost-reduction, miniaturization, or thin modeling.

Further, an image capturing apparatus employs a compound-eye optical system, such as a microlens array, to obtain a thinner image capturing apparatus. The compound-eye optical system includes a plurality of imaging lenses. The respective imaging lenses focus single-eye images to form a compound-eye image.

The image capturing apparatus picks up the compound-eye image by an image pickup device. Then the image capturing apparatus reconstructs a single object image from the single-eye images constituting the compound-eye image.

For example, an image capturing apparatus employs a microlens array including a plurality of imaging lenses. The respective imaging lenses form single-eye images. The image capturing apparatus reconstructs a single object image by utilizing parallaxes between the single-eye images.

Thus, using the microlens array, the image capturing apparatus attempts to reduce the back-focus distance to achieve a thin imaging optical system. Further, using the plurality of single-eye images, the image capturing apparatus attempts to correct degradation in resolution due to a relatively small number of pixels per single-eye image.

However, such an image capturing apparatus may not effectively correct image degradation due to the imaging optical system.

### SUMMARY

At least one embodiment of the present specification provides an image capturing apparatus including an imaging lens, an image pickup device, and a correcting circuit. The imaging lens is configured to focus light from an object to form an image. The image pickup device is configured to pick up the image formed by the imaging lens. The correcting circuit is configured to execute computations for correcting degradation of the image caused by the imaging lens. The imaging lens is also a single lens having a finite gain of optical transfer function and exhibiting a minute difference in the gain between different angles of view of the imaging lens.

Further, at least one embodiment of the present specification provides an image capturing apparatus including a lens array, a reconstructing circuit, and a reconstructing-image correcting circuit. The lens array also includes an array of a plurality of imaging lenses The lens array is configured to form a compound-eye image including single-eye images of the object. The single-eye images are formed by the respective imaging lenses. The reconstructing circuit is configured to execute computations for reconstructing a single object image from the compound-eye image formed by the lens array. The reconstructing-image correcting circuit is configured to execute computations for correcting image degradation of the single object image reconstructed by the reconstructing circuit.

Additional features and advantages of the present invention will be more fully apparent from the following detailed description of example embodiments, the accompanying drawings and the associated claims.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view illustrating a configuration of an image capturing apparatus according to an exemplary embodiment of the present invention;

FIG. 2A is a schematic view illustrating optical paths of an imaging lens observed when the convex surface of the imaging lens faces an image surface;

FIG. 2B is a schematic view illustrating optical paths of the imaging lens of FIG. 2A observed when the convex surface thereof faces an object surface;

FIG. 2C is a graph illustrating MTF (modulation transfer function) values of the light fluxes of FIG. 2A;

FIG. 2D is a graph illustrating MTF values of the light fluxes of FIG. 2B;

FIG. 3A is a schematic view illustrating a configuration of an image capturing apparatus according to another exemplary embodiment of the present invention;

FIG. 3B is a partially enlarged view of the lens array system and image pickup device illustrated in FIG. 3A;

FIG. 3C is a schematic view illustrating an example of a compound-eye image that is picked up by the image pickup device;

FIG. 4 is a three-dimensional graph illustrating an example of the change of the least square sum of brightness deviations depending on two parallax parameters;

FIG. 5 is a schematic view illustrating a method of reconstructing a single object image from a compound-eye image;

FIG. 6 is a flow chart illustrating an exemplary sequential flow of an image degradation correcting and reconstructing process of a single object image;

FIG. 7 is a flow chart of another exemplary sequential flow of an image degradation correcting and reconstructing process of a single object image;

FIG. 8 is a graph illustrating an example of the change of MTF depending on the object distance of the imaging lens; and

FIG. 9 is a schematic view illustrating an example of a pixel array of a color CCD camera.

The accompanying drawings are intended to depict exemplary embodiments of the present invention and should not be interpreted to limit the scope thereof. The accompanying drawings are not to be considered as drawn to scale unless explicitly noted.

### DETAILED DESCRIPTION OF EXAMPLE EMBODIMENTS

The terminology used herein is for the purpose of describing exemplary embodiments only and is not intended to be limiting of the present invention. As used herein, the singular forms “a”, “an” and “the” are intended to include the plural forms as well, unless the context clearly indicates otherwise: It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing exemplary embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner.

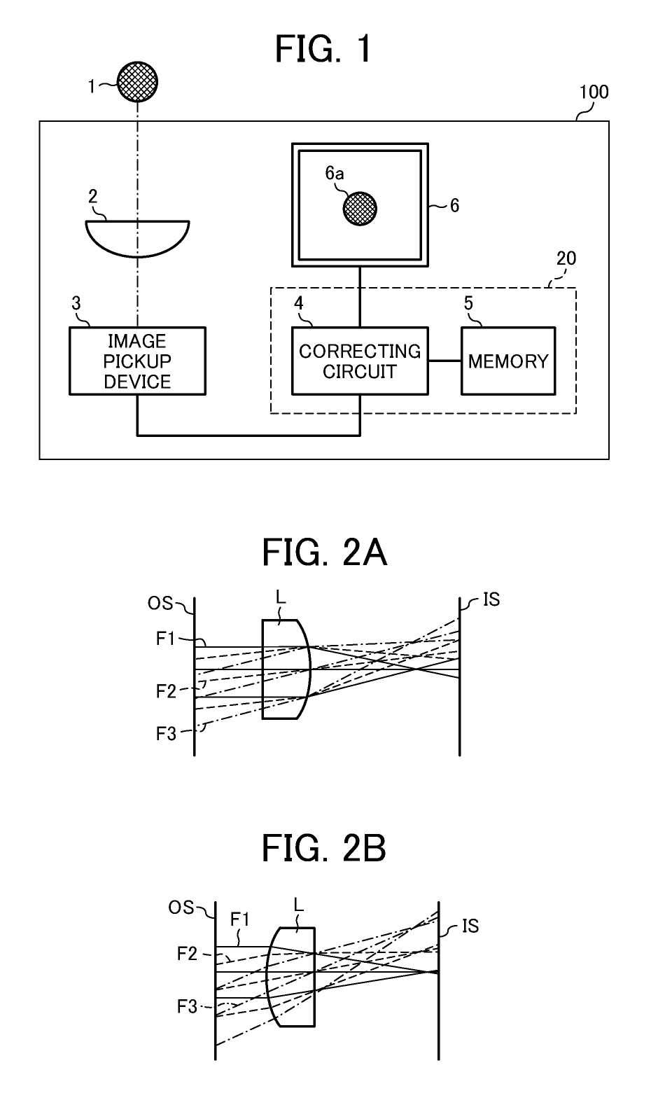

Referring now to the drawings, wherein like reference numerals designate identical or corresponding parts throughout the several views, FIG. 1 is a schematic view illustrating a configuration of an image capturing apparatus 100 according to an exemplary embodiment of the present invention.

As illustrated in FIG. 1, the image capturing apparatus 100 may include an imaging lens 2, an image pickup device 3, a correcting circuit 4, a memory 5, and an image display 6, for example.

In FIG. 1, the imaging lens 2 may be a plane-convex lens having a spherically-shaped convex surface. The image pickup device 3 may be a CCD or CMOS camera. The image display 6 may be a liquid-crystal display, for example.

The correcting circuit 4 and the memory 5 may configure a correcting circuit unit 20. The correcting circuit unit 20 also constitutes a part of a control section for controlling the image capturing apparatus 100 as a whole.

As illustrated in FIG. 1, the imaging lens 2 is positioned so that a plane surface thereof faces an object 1 while a convex surface thereof faces the image pickup device 3.

The imaging lens 2 focuses light rays from the object 1 to form an image of the object 1 on the pickup surface of the image pickup device 3. The image pickup device 3 picks up the image of the object 1, and transmits the picked image data to the correcting circuit 4.

The memory 5 stores OTF data, OTF(x,y), of the imaging lens 2. The OTF data is obtained as follows. First, the wave aberration of the imaging lens 2 is calculated by ray trace simulation. Then, the pupil function of the imaging lens 2 is determined from the wave aberration. Further, an autocorrelation calculation is executed on the pupil function, thus producing the OTF data.

The correcting circuit 4 reads the OTF data from the memory 5 and executes correcting computations on the picked image data using the OTF data. The correcting circuit 4 also outputs the corrected image data to the image display 6. The image display 6 displays a reproduced image 6a based on the corrected image data.

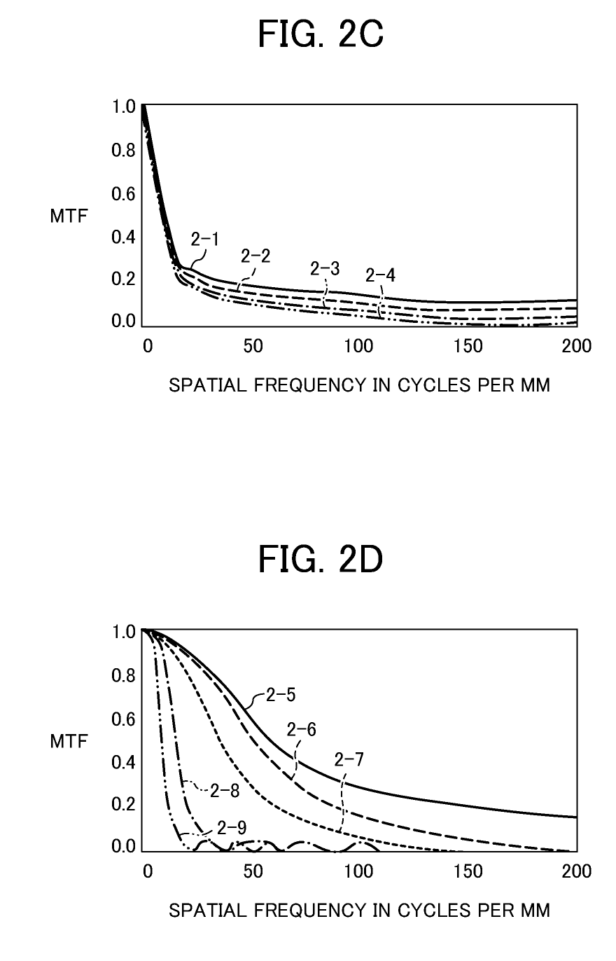

Next, an effect of the orientation of imaging lens on a focused image is described with reference to FIGS. 2A to 2D. An imaging lens L of FIG. 2A and 2B is configured as a plane-convex lens.

FIG. 2A is a schematic view illustrating optical paths of the imaging lens L observed when the convex surface of the imaging lens L faces a focused image. FIG. 2B is a schematic view illustrating optical paths of the imaging lens L observed when the convex surface thereof faces an object surface OS as conventionally performed.

In FIGS. 2A and 2B, three light fluxes F1, F2, and F3 may have different incident angles relative to the imaging lens L.

The light fluxes F1, F2, and F3 of FIG. 2A exhibit relatively lower focusing characteristics and lower ray densities compared to the light fluxes F1, F2, and F3 of FIG. 2B. Therefore, the light fluxes F1, F2, and F3 of FIG. 2A exhibit relatively small differences to one another on the image surface IS.

On the other hand, the light fluxes F1, F2, and F3 of FIG. 2B exhibit relatively higher focusing characteristics compared to the light fluxes F1, F2, and F3 of FIG. 2A. Thus, the light fluxes F1, F2, and F3 of FIG. 2B exhibit relatively large differences to one another on the image surface IS.

Such a relationship between the orientation of the imaging lens L and the focused image can be well understood by referring to MTF (modulation transfer function) indicative of the gain of OTF of the imaging lens L.

FIG. 2C is a graph illustrating MTF values of the light fluxes F1, F2, and F3 obtained when the imaging lens L is positioned as illustrated in FIG. 2A.

On the other hand, FIG. 2D is a graph illustrating MTF values of the light fluxes F1, F2, and F3 obtained when the imaging lens L is positioned as illustrated in FIG. 2B.

A comparison of FIGS. 2C and 2D provides a clear difference in MTF between the imaging states of FIGS. 2A and 2B.

In FIG. 2C, line 2-1 represents the MTF values of the imaging lens L for the light flux F1 on both sagittal and tangential planes. The observed difference in MTF between the two planes is too small to be graphically distinct.

Line 2-2 represents the MTF values of the imaging lens L for the light flux F2 on both sagittal and tangential planes. The observed difference in MTF between the two planes is too small to be graphically distinct in FIG. 2C.

For the light flux F3, lines 2-3 and 2-4 represent MTF values of the imaging lens L on both sagittal and tangential planes, respectively. As illustrated in FIG. 2A, the light flux F3 has a relatively large incident angle relative to the imaging lens L compared to the light fluxes F1 and F2. The observed difference in MTF between the sagittal and tangential planes is graphically distinct in FIG. 2C.

Thus, in the imaging state of FIG. 2A, the imaging lens L exhibits a lower focusing performance, which results in generally finite and low MTF values. However, the imaging lens L exhibits small differences in MTF between the light fluxes F1, F2, and F3, which are caused by the differences in the incident angle.

Thus, when the imaging lens L forms an object image with the convex surface thereof facing the image, the MTF values of the imaging lens L are generally finite and lower regardless of incident angles. The MTF values are also not so influenced by the difference in the incident angle of light.

In the imaging state of FIG. 2B, the light flux, such as F1, having a small incident angle, exhibits a negligible difference in MTF between the sagittal and tangential planes. Thus, a preferable MTF characteristic is obtained.

On the other hand, the larger the incident angle of light as indicated by F2 and F3, the smaller the MTF value.

In FIG. 2D, lines 2-6 and 2-7 represent the sagittal and tangential MTF curves, respectively, of the imaging lens L for the light flux F2. Lines 2-8 and 2-9 represent the sagittal and tangential MTF curves, respectively, of the imaging lens L for the light flux F3.

When the OTF data of a lens system is available, image degradation due to an OTF-relating factor can be corrected in the following manner.

When an object image formed on the image surface is degraded by a factor relating to the lens system, the light intensity of the object image are expressed by Equation 1:

I(x,y)=FFT⁻¹[FFT{S(x,y)×OTF(x,y)] 1

where “x” and “y” represent position coordinates in the image pick-up surface, “I(x,y)” represents light intensity of the object image picked up by the image pickup device, “S(x,y)” represents light intensity of the object, and “OTF(x,y)” represents OTF of the imaging lens. Further, FFT represents a Fourier transform operator, while FFT⁻¹ represents an inverse Fourier transform operation.

More specifically, the light intensity “I(x,y)” represents light intensity on the image pickup surface of an image sensor such as a CCD or CMOS image sensor.

The OTF(x,y) in Equation 1 can be obtained in the following manner. First, the wave aberration of the imaging lens is determined by ray-tracing simulation. Based on the wave aberration, the pupil function of the imaging lens is calculated. Further, an autocorrelation calculation is executed on the pupil function, thereby producing the OTF data. Thus, the OTF data can be obtained in advance depending on the imaging lens used in the image capturing apparatus 100.

If the FFT is applied to both sides of Equation 1, Equation 1 is transformed into:

FFT{I(x,y)}=[FFT{S(x,y)}×OTF(x,y)] 1a

Further, the above Equation 1a is transformed into:

FFT{S(x,y)}=FFT{I(x,y)}/OTF(x,y) 1b

In this regard, when R(x,y) represents the light intensity of the reproduced image, the more exact correspondence the R(x,y) exhibits to the S(x,y), the more precisely the object is reproduced by the reproduced image.

When the OTF(x,y) is obtained for the imaging lens in advance, the light intensity of the image R(x,y) can be determined by applying FFT⁻¹ to the right side of the above Equation 1b. Therefore, the light intensity of the image R(x,y) can be expressed by Equation 2:

R(x,y)=FFT⁻¹[FFT{I(x,y)}/OTF(x,y)+α] 2

where “α” represents a constant that is used to prevent an arithmetic error such as division-by-zero and suppress noise amplification. In this regard, the more precise the OTF(x,y) data is, the more closely light intensity of the image R(x,y) reflects the light intensity of the object S(x,y). Thus, precisely reproduced image can be obtained.

Thus, when OTF data is obtained in advance for an imaging lens, the image capturing apparatus 100 can provide a preferable reproduced image by executing correcting computations using Equation 2.

For the correcting computation using Equation 2, when the convex surface of the imaging lens faces the object surface OS as illustrated in FIG. 2B, a higher quality image may not be obtained even if the correcting computations using Equation 2 is performed.

In such a case, the OTF of the imaging lens may significantly change depending on the incident angle of light. Therefore, even if a picked image is corrected based on only one OTF value, for example, an OTF value of the light flux F1, a sufficient correction may not be achieved for the picked image as a whole. Consequently, a higher quality reproduced image may not be obtained.

In order to perform a sufficient correction, different OTF values may be used in accordance with the incident angles of light. However, when the difference in OTF between the incident angles is large, a relatively large number of OTF values in accordance with the incident angles of light are preferably used for the correcting computations. Such correcting computations may need a considerably longer processing time. Therefore, the above discussed correcting process is not so advantageous.

Further, when the minimum unit to be corrected is a pixel of the image pickup device, the OTF data with precision below the pixel are not available. Therefore, the larger the difference in OTF between the incident angles, the larger the error in the reproduced image.

On the other hand, when the convex surface of the imaging lens L faces the image surface IS as illustrated in FIG. 2A, the difference in OTF between different incident angles of light may be smaller. Further, the OTF values of the imaging lens L are substantially identical for different incident angles of light.

Thus, in the imaging state of FIG. 2A, the image capturing apparatus 100 can obtain the finite and lower OTF values of the imaging lens L, which are not so influenced by the difference in incident angle of light.

Hence, an optical image degradation can be corrected by executing the above-described correcting computations using an OTF value for any one incident angle or an average OTF value for any two incident angles. Alternatively, different OTF values corresponding to incident angles may be used.

Using an OTF value for one incident angle can reduce the processing time for the correcting computations. Further, even when different OTF values corresponding to the incident angles are used to increase the correction accuracy, the correcting computations can be executed based on a relatively small amount of OTF data, thereby reducing the processing time.

Thus, the image capturing apparatus 100 can reproduce an image having a higher quality by using a simple single lens such as a plane-convex lens as the imaging lens.

In the imaging state of FIG. 2A, the effect of the incident angle on the OTF is relatively small as illustrated in FIG. 2C. The smaller effect indicates that, even if the imaging lens is positioned with an inclination, the OTF is not significantly influenced by the inclination.

Therefore, positioning the imaging lens L as illustrated in FIG. 2A can effectively suppress undesirable effects of an inclination error of the imaging lens L, which may occur when the imaging lens L is mounted on the image capturing apparatus 100.

When the imaging lens L exhibits a higher focusing performance, as illustrated in FIG. 2B, a slight shift of the image surface IS in a direction along the optical axis may enlarge the extent of the focusing point, thereby causing image degradation.

Meanwhile, when the imaging lens L exhibits a lower focusing performance as illustrated in FIG. 2A, a slight shift of the image surface IS in a direction along the optical axis may not significantly enlarge the extent of the focusing point. Therefore, undesirable effects may be suppressed that may be caused by an error in the distance between the imaging lens and the image surface IS.

In the above description, the frequency filtering using FFT is explained as a method of correcting a reproduced image in the image capturing apparatus 100.

However, as the correcting method, deconvolution computation using point-spread function (PSF) may be employed. The deconvolution computation using PSF can correct an optical image degradation similar to the above frequency filtering.

The deconvolution computation using PSF may be a relatively simple computation compared to a Fourier transform, and therefore can reduce the manufacturing cost of a specialized processing circuit.

As described above, the image capturing apparatus 100 uses, as the imaging lens, a single lens having a finite OTF gain and a minute difference in OTF between the incident angles of light. Since the OTF values of the single lens are finite, lower, and substantially uniform regardless of the incident angle of light, the correcting computation of the optical image degradation can be facilitated, thus reducing the processing time.

In the above description of the present exemplary embodiment, the single lens for use in the image capturing apparatus 100 has a plane-convex shape. The convex surface thereof is spherically shaped and faces a focused image.

Alternatively, the single lens may also be a meniscus lens, of which the convex surface faces a focused image. The single lens may also be a GRIN (graded index) lens, or a diffraction lens such as a hologram lens or a Fresnel lens as long as the single lens has a zero or negative power on the object side and a positive power on the image side.

The single lens for use in the image capturing apparatus 100 may also be an aspherical lens. Specifically, the above convex surface of the plane-convex lens or the meniscus lens may be aspherically shaped.

In such a case, a low-dimension aspheric constant such as a conical constant, may be adjusted so as to reduce the dependency of OTF on the incident angle of light. The adjustment of the aspheric constant can reduce the difference in OTF between the incident angles, thereby compensating a lower level of MTF.

The above correcting method of reproduced images is applicable to a whole range of electromagnetic waves including infrared rays and ultraviolet rays. Therefore, the image capturing apparatus 100, according to the present exemplary embodiment, is applicable to infrared cameras such as monitoring cameras and vehicle-mounted cameras.

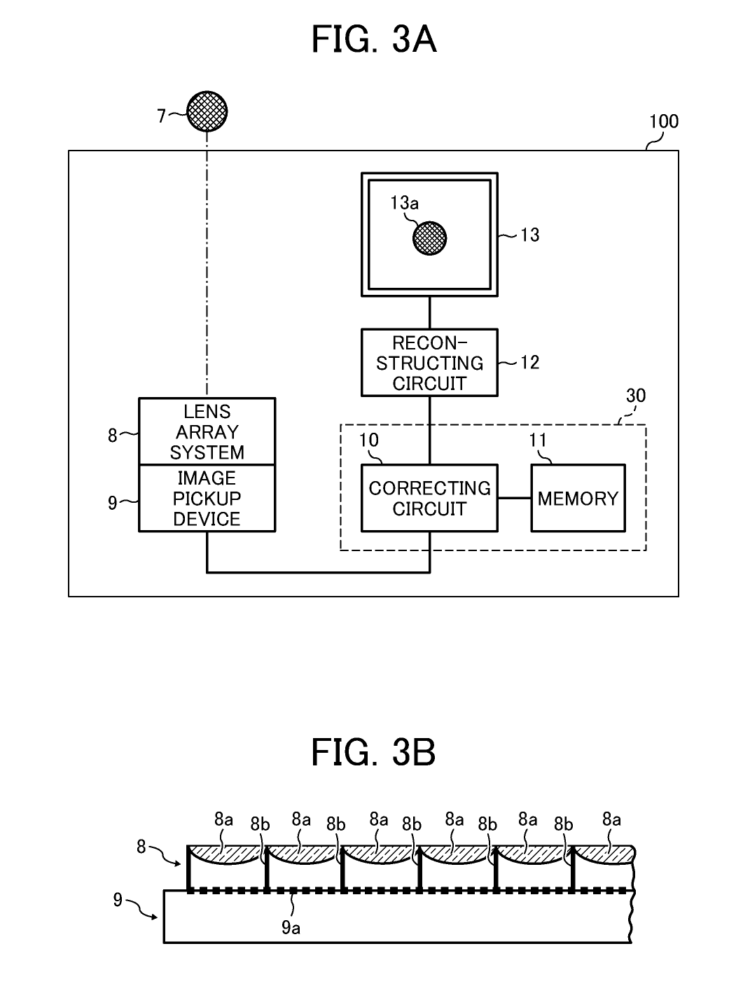

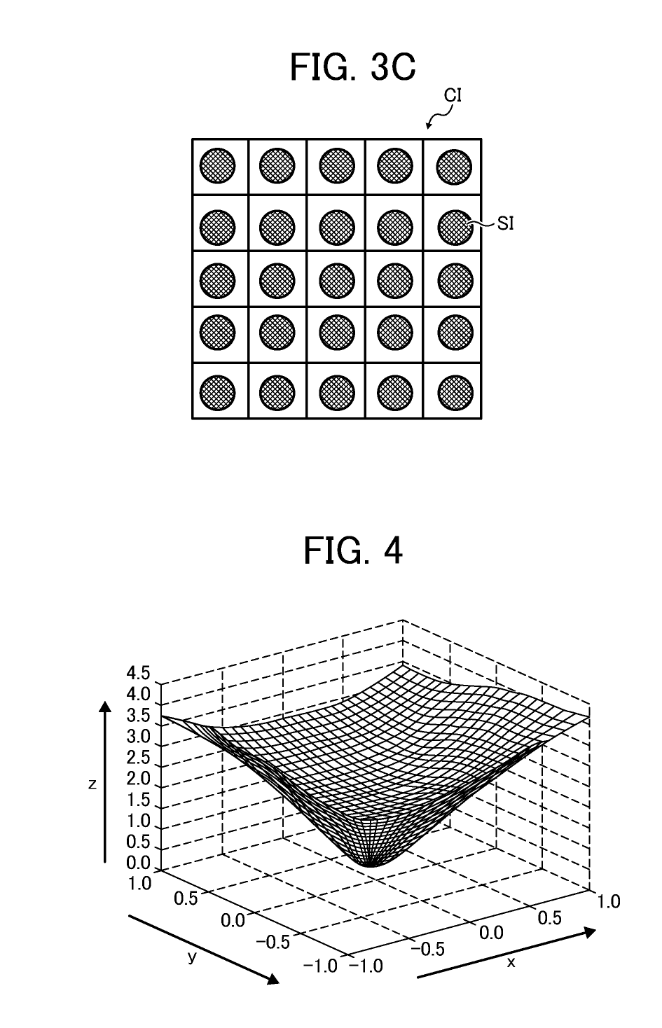

Next, an image capturing apparatus 100 according to another exemplary embodiment of the present invention is described with reference to FIGS. 3A to 3C.

FIG. 3A illustrates a schematic view of the image capturing apparatus 100 according to another exemplary embodiment of the present invention. The image capturing apparatus 100 may include a lens array system 8, an image pickup device 9, a correcting circuit 10, a memory 11, reconstructing circuit 12, and an image display 13. The image capturing apparatus 100 reproduces an object 7 as a reproduced image 13a on the image display 13, for example.

The correcting circuit 10 and the memory 11 may configure a reconstructed-image correcting unit 30. The reconstructed-image correcting unit 3C and the reconstructing circuit 12 also constitute a part of a control section for controlling the image capturing apparatus 100 as a whole.

FIG. 3B is a partially enlarged view of the lens array system 8 and the image pickup device 9 illustrated in FIG. 3A.

The lens array system 8 may include a lens array 8a and a light shield array 8b. The lens array 8a may also include an array of imaging lenses. The light shield array 8b may also include an array of light shields.

Specifically, according to the present exemplary embodiment, the lens array 8a may employ, as the imaging lenses, a plurality of plane-convex lenses that are optically equivalent to one another. The lens array 8a may also have an integral structure in which the plurality of plane-convex lenses are two-dimensionally arrayed.

The plane surface of each plane-convex lens faces the object side, while the convex surface thereof faces the image side. Each plane-convex lens is made of resin, such as transparent resin. Thereby, each plane-convex lens may be molded by a glass or metal mold according to a resin molding method. The glass or metal mold may also be formed by a reflow method, an etching method using area tone mask, or a mechanical fabrication method.

Alternatively, each plane-convex lens of the lens array 8a may be made of glass instead of resin.

The light shield array 8b is provided to suppress flare or ghost images that may be caused by the mixture of light rays, which pass through adjacent imaging lenses, on the image surface.

The light shield array 8b is made of a mixed material of transparent resin with opaque material such as black carbon. Thus, similar to the lens array 8a, the light shield array 8b may be molded by a glass or metal mold according to a resin molding method. The glass or metal mold may also be formed by an etching method or a mechanical fabrication method.

Alternatively, the light shield array 8b may be made of metal such as stainless steel, which is black-lacquered, instead of resin.

According to the present exemplary embodiment, the corresponding portion of the light shield array 8b to each imaging lens of the lens array 8a may be a tube-shaped shield. Alternatively, the corresponding portion may be a tapered shield or a pinhole-shaped shield.

Both the lens array 8a and the light shield array 8b may be made of resin. In such a case, the lens array 8a and the light shield array 8b may be integrally molded, which can increase efficiency in manufacturing.

Alternatively, the lens array 8a and the light shield array 8b may be separately molded and then assembled after the molding.

In such a case, the respective convex surfaces of the lens array 8a facing the image side can engage into the respective openings of the light shield array 8b, thus facilitating alignment between the lens array 8a and the light shield array 8b.

According to the present example embodiment, the image pickup device 9 illustrated in FIG. 3A or 3B is an image sensor, such as a CCD image sensor or a CMOS image sensor, in which photodiodes are two-dimensionally arranged. The image pickup device 9 is disposed so that the respective focusing points of the plane-convex lenses of the lens array 8a are substantially positioned on the image pickup surface.

FIG. 3C is a schematic view illustrating an example of a compound-eye image CI picked up by the image pickup device 9. For simplicity, the lens array 8a is assumed to have twenty-five imaging lenses (not illustrated). The twenty-five imaging lenses are arranged in a square matrix form of 5×5. The matrix lines separating the single-eye images SI in FIG. 3C indicate the shade of the light shield array 8b.

As illustrated in FIG. 3C, the imaging lenses form respective single-eye images SI of the object 7 on the image surface. Thus, the compound-eye image CI is obtained as an array of the twenty five single-eye images SI.

The image pickup device 9 includes a plurality of pixels 9a to pick up the single-eye images SI as illustrated in FIG. 3B. The plurality of pixels 9a are arranged in a matrix form.

Suppose that the total number of pixels 9a of the image pickup device 9 is 500×500 and the array of imaging lenses of the lens array 8a is 5×5. Then, the number of pixels per imaging lens becomes 100×100. Further, suppose that the shade of the light shield array 8b covers 10×10 pixels per imaging lens. Then, the number of pixels 9a per single-eye image SI becomes 90×90.

Then, the image pickup device 9 picks up the compound-eye image CI as illustrated in FIG. 3C to generate compound-eye image data. The compound-eye image data is transmitted to the correcting circuit 10.

The OTF data of the imaging lenses of the lens array 8a is calculated in advance and is stored in the memory 11. Since the imaging lenses are optically equivalent to one another, only one OTF value may be sufficient for the following correcting computations.

The correcting circuit 10 reads the OTF data from the memory 11 and executes correcting computations for the compound-eye image data transmitted from the image pickup device 9. According to the present exemplary embodiment, the correcting circuit 10 separately executes correcting computations for the respective single-eye images SI constituting the compound-eye image. At this time, the correcting computations are executed using Equation 2.

Thus, the correcting circuit 10 separately executes corrections for the respective single-eye images SI constituting the compound-eye image CI based on the OTF data of the imaging lenses. Thereby, the compound-eye image data can be obtained that are composed of corrected data of the single-eye images SI.

Then, the reconstructing circuit 12 executes processing for reconstructing a single object image based on the compound-eye image data.

As described above, the single-eye images SI constituting the compound-eye image CI are images of the object 7 formed by the imaging lenses of the lens array 8a. The respective imaging lenses have different positional relationships relative to the object 7. Such different positional relationships generate parallaxes between the single-eye images. Thus, the single-eye images are obtained that are shifted from each other in accordance with the parallaxes.

Incidentally, the “parallax” in this specification refers to the amount of image shift between a reference single-eye image and each of the other single-eye images. The image shift amount is expressed by length.

If only one single-eye image is used as the picked image, the image capturing apparatus 100 may not reproduce the details of object 7 that are smaller than one pixel of the single-eye image.

On the other hand, if a plurality of single-eye images are used, the image capturing apparatus 100 can reproduce the details of the object 7 by utilizing the parallaxes between the plurality of single-eye images as described above. In other words, by reconstructing a single object image from a compound-eye image including parallaxes, the image capturing apparatus 100 can provide a reproduced object image having an increased resolution for the respective single-eye images SI.

Detection of the parallax between single-eye images can be executed based on the least square sum of brightness deviation between the single-eye images, which is defined by Equation 3.

Eₘ=ΣΣ{I_{B}(x,y)−Iₘ(x−pₓ,y−p_{y})}² 3

where I_{B}(x,y) represents light intensity of a reference single-eye image selected from among the single-eye images constituting the compound-eye image.

As described above, the parallaxes between the single-eye images refers to the parallax between the reference single-eye image and each of the other single-eye images. Therefore, the reference single-eye image serves as a reference of parallax for the other single-eye images.

A subscript “m” represents the numerical code of each single-eye image, and ranges from one to the number of lenses in the lens array 8a. In other words, the upper limit of “m” is equal to the total number of single-eye images.

When pₓ=p_{y}=0 is satisfied in the term Iₘ(x−pₓ, y−p_{y}) of Equation 3, Iₘ(x,y) represents the light intensity of the m-th single-eye image, and pₓ and p_{y} represent parameters for determining parallaxes thereof in the x and y directions, respectively.

The double sum in Equation 3 represents the sum of the pixels in the x and y directions of the m-th single-eye image. The double sum is executed in the ranges from one to X for “x” and from one to Y for “y”. In this regard, “X” represents the number of pixels in the “x” direction of the m-th single-eye image, and “Y” represents the number of pixels in the “y” direction thereof.

For all of the pixels composing a given single-eye image, the brightness deviation is calculated between the single-eye image and the reference single-eye image. Then, the least square sum Eₘ of the brightness deviation is determined.

Further, each time the respective parameters pₓ and p_{y} are incremented by one pixel, the least square sum Eₘ of the brightness deviation is calculated using Equation 3. Then, values of the parameters pₓ and p_{y} producing a minimum value of the least square sum Eₘ can be regarded as the parallaxes Pₓ and P_{y} in the x and y directions, respectively, of the single-eye image relative to the reference single-eye image.

Suppose that when a first single-eye image (m=1), constituting a compound-eye image, is selected as the reference single-eye image, the parallaxes of the first single-eye image itself are calculated. In such a case, the first single-eye image is identical with the reference single-eye image.

Therefore, when pₓ=p_{y}=0 is satisfied in Equation 3, the two single-eye images are completely overlapped. Then the least square sum Eₘ of brightness deviation becomes zero in Equation 3.

The larger the absolute values of pₓ and p_{y}, the less overlapping there is between the two single-eye images, and the least square sum Eₘ value is larger. Therefore, the parallaxes Pₓ and P_{y} between the identical single-eye images become zero.

Next, suppose that for the parallaxes of the mth single-eye image, Pₓ=3 and P_{y}=2 are satisfied in Equation 3. In such a case, the m-th single-eye image is shifted by three pixels in the x direction and by two pixels in the y direction relative to the reference single-eye image.

Hence, the m-th single-eye image is shifted by minus three pixels in the x direction and by minus two pixels in the y direction relative to the reference single-eye image. Thus, the m-th single-eye image can be corrected so as to precisely overlap the reference single-eye image. Then, the least square sum Eₘ of brightness deviation takes a minimum value.

FIG. 4 is a three-dimensional graph illustrating an example of the change of the least square sum Eₘ of brightness deviation depending on the parallax parameters pₓ and p_{y}. In the graph, the x axis represents pₓ, the y axis represents p_{y}, and the z axis represents Eₘ.

As described above, the values of parameters pₓ and p_{y} producing a minimum value of the least square sum Eₘ can be regarded as the parallaxes Pₓ and P_{y} of the single-eye image in the x and y directions, respectively, relative to the reference single-eye image.

The parallaxes Pₓ and P_{y} are each defined as an integral multiple of the pixel size. However, when the parallax Pₓ or P_{y} is expected to be smaller than the size of one pixel of the image pickup device 9, the reconstructing circuit 12 enlarges the m-th single-eye image so that the parallax Pₓ or P_{y} becomes an integral multiple of the pixel size.

The reconstructing circuit 12 executes computations for interpolating a pixel between pixels to increase the number of pixels composing the single-eye image. For the interpolating computation, the reconstructing circuit 12 determines the brightness of each pixel with reference to adjacent pixels. Thus, the reconstructing circuit 12 can calculate the parallaxes Pₓ and P_{y} based on the least square sum Eₘ of brightness deviation between the enlarged single-eye image and the reference single-eye image.

The parallaxes Pₓ and P_{y} can be roughly estimated in advance based on the following three factors: the optical magnification of each imaging lens of the lens array 8a, the lens pitch of the lens array 8a, and the pixel size of the pickup image device 9.

Therefore, the scale of enlargement used in the interpolation computation may be determined so that each estimated parallax has the length of an integral multiple of the pixel size.

When the lens pitch of the lens array 8a is formed with relatively high accuracy, the parallaxes Pₓ and P_{y} can be calculated based on the distance between the object 7 and each imaging lens of the lens array 8a.

According to a parallax detecting method, first, the parallaxes Pₓ and P_{y} of a pair of single-eye images are detected. Then, the object distance between the object and each of the imaging lens is calculated using the principle of triangulation. Based on the calculated object distance and the lens pitch, the parallaxes of the other single-eye images can be geometrically determined. In this case, the computation processing for detecting parallaxes is executed only once, which can reduce the computation time.

Alternatively, the parallaxes may be detected using another known parallax detecting method instead of the above-described parallax detecting method using the least square sum of brightness deviation.

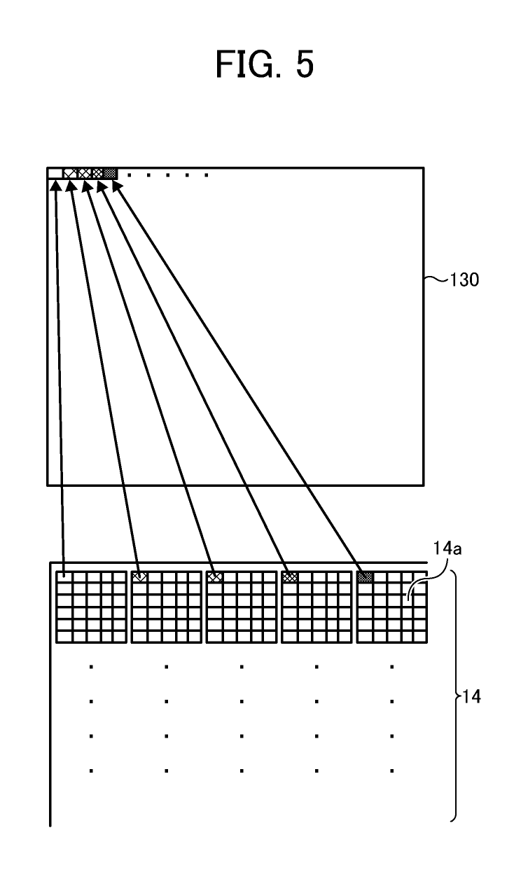

FIG. 5 is a schematic view illustrating a method of reconstructing a single object image from a compound-eye image.

According to the reconstructing method as illustrated in FIG. 5, first pixel brightness data is obtained from a single-eye image 14a constituting a compound eye image 14. Based on the position of the single eye-image 14a and the detected parallaxes, the obtained pixel brightness data is located at a given position of a reproduced image 130 in a virtual space.

The above locating process of pixel brightness data is repeated for all pixels of each single-eye image 14a, thus generating the reproduced image 130.

Here, suppose that the left-most single-eye image 14a in the uppermost line of the compound-eye image 14 in FIG. 5 is selected as the reference single-eye image. Then the parallaxes Pₓ of the single-eye images arranged on the right side thereof become, in turn, −1, −2, −3, etc.

The pixel brightness data of the leftmost and uppermost pixel of each single-eye image is in turn located on the reproduced image 130. At this time, the pixel brightness data is in turn shifted by the parallax value in the right direction of FIG. 5, which is the plus direction of the parallax.

When one single-eye image 14a has: parallaxes Pₓ and P_{y} relative to the reference single-eye image, the single-eye image 14a is shifted by the minus value of each parallax in the x and y directions as described above. Thereby, the single-eye image is most closely overlapped with the reference single-eye image. The overlapped pixels between the two images indicate substantially identical portions of the object 7.

However, the shifted single-eye image and the reference single-eye image are formed by the imaging lenses having different positions in the lens array 8a. Therefore, the overlapped pixels between the two images does not indicate completely identical portions, but substantially identical portions.

Hence, the image capturing apparatus 100 uses the object image data picked up in the pixels of the reference single-eye image together with the object image data picked up in the pixels of the shifted single-eye image. Thereby, the image capturing apparatus 100 can reproduce details of the object 7 that are smaller than one pixel of the single-eye image.

Thus, the image capturing apparatus 100 reconstructs a single object image from a compound-eye image including parallaxes. Thereby, the image capturing apparatus 100 can provide a reproduced image of the object 7 having an increased resolution for the single-eye images.

A relatively large parallax or the shade of the light shield array 8b may generate a pixel that has lost the brightness data. In such a case, the reconstructing circuit 12 interpolates the lost brightness data of the pixel by referring to the brightness data of adjacent pixels.

As described above, when the parallax is smaller than one pixel, the reconstructed image is enlarged so that the amount of parallax becomes equal to an integral multiple of the pixel size. At the time, the number of pixels constituting the reconstructed image are increased through the interpolating computation. Then, the pixel brightness data is located at a given position of the enlarged reconstructed image.

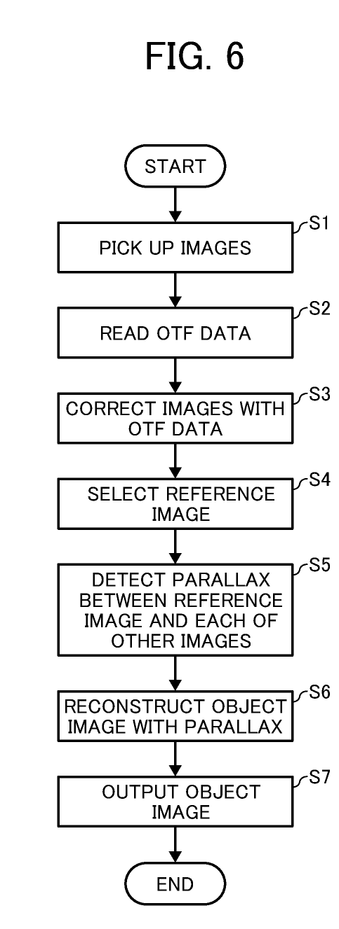

FIG. 6 is a flow chart illustrating a sequential flow of a correcting process of image degradation and a reconstructing process of a single object image as described above.

At step S1, the image pickup device 9 picks up a compound-eye image.

At step S2, the correcting circuit 10 reads the OTF data of a lens system. As described above, the OTF data is calculated in advance by ray-tracing simulation and is stored in the memory 11.

At step S3, the correcting circuit 10 executes computations for correcting image degradation in each single-eye image based on the OTF data. Thereby, a compound-eye image including the corrected single-eye images is obtained.

At step S4, the reconstructing circuit 12 selects a reference single-eye image for use in determining the parallaxes of each single-eye image.

At step S5, the reconstructing circuit 12 determines the parallaxes between the reference single-eye image and each of the other single-eye images.

At step S6, the reconstructing circuit 12 executes computations for reconstructing a single object image from the compound-eye image using the parallaxes.

At step S7, the single object image is output.

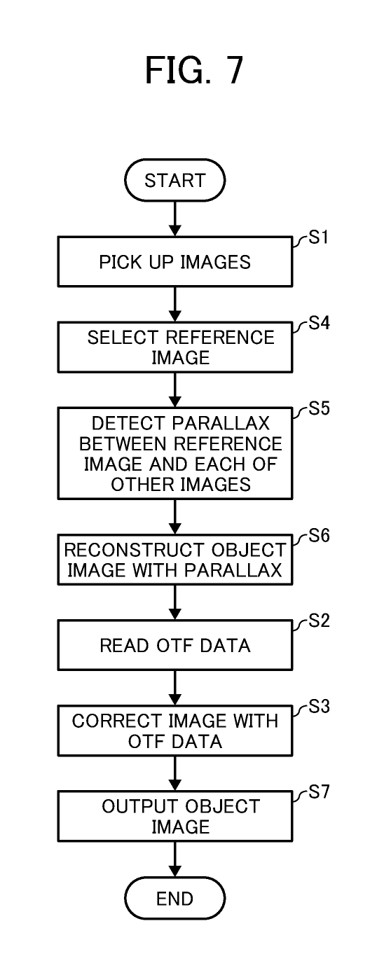

FIG. 7 is a flow chart of another sequential flow of the image-degradation correcting process and the reconstructing process of FIG. 6. In FIG. 7, the steps of the sequential flow of FIG. 6 are partially arranged in a different sequence.

At step S1a, the image pickup device 9 picks up a compound-eye image.

At step S2a, the reconstructing circuit 12 selects a reference single-eye image for use in determining the parallax of each single-eye image.

At step S1a, the reconstructing circuit 12 determines the parallax between the reference single-eye image and each single-eye image.

At step S4a, the reconstructing circuit 12 executes computations to reconstruct a single object image from the compound-eye image using the parallaxes.

At step S5a, the correcting circuit 10 reads the OTF data of the lens system from the memory 11.

At step S6a, the correcting circuit 10 executes computations to correct image degradation in the single object image based on the OTF data.

At step S7a, the single object image is output.

In the sequential flow of FIG. 7, the computation processing for correcting image degradation based on the OTF data is executed only once. Therefore, the computation time can be reduced as compared to the sequential flow of FIG. 6.

However, since the OTF data is inherently related to the respective single-eye images, applying the OTF data to the reconstructed single object image may increase an error in the correction as compared to the sequential flow of FIG. 6.

Next, for the imaging lenses of the lens array 8a of the present exemplary embodiment, a preferable constitution is examined to obtain a lower difference in MTF between angles of view.

According to the present exemplary embodiment, each imaging lens may be a plane-convex lens, of which the convex surface is disposed to face the image side. Each imaging lens may be made of acrylic resin.

For parameters of each imaging lens, “b” represents the back focus, “r” represents the radius of curvature, “t” represents the lens thickness, and “D” represents the lens diameter.

To find a range in which finite and uniform OTF gains can be obtained within the expected angle of view relative to an object, the three parameters “b”, “t”, and “D” are randomly changed in a graph of MTF. Then, each imaging lens exhibits a relatively lower difference in MTF between the angles of view when the above parameters satisfies the following conditions:

1.7≦|b/r|≦2.4;

≦|t/r|1.7; and

≦|D/r|≦3.8.

When the parameters deviate from the above ranges, the MTF may drop to zero or reduce uniformity. On the other hand, when the parameters satisfy the above ranges, the lens diameter of the imaging lens becomes shorter and the F-number thereof becomes smaller. Thus, a relatively bright imaging lens having a deep depth-of-field can be obtained.

Here, suppose that each of the imaging lenses of the lens array 8a of FIG. 3 is made of acrylic resin. Further, the radius “r” of curvature of the convex surface, the lens diameter “D”, and the lens thickness “t” are all set to 0.4 mm. The back focus is set to 0.8 mm.

In such an arrangement, the parameters b/r, t/r, and D/r are equal to 2.0, 1.0, and 1.0, respectively, which satisfy the above conditions.

FIG. 2C illustrates the MTF of the imaging lens having the above constitution. The graph of FIG. 2C illustrates that the imaging lens is not significantly affected by an error in the incident angle of light relative to the imaging lens or a positioning error of the imaging lens.

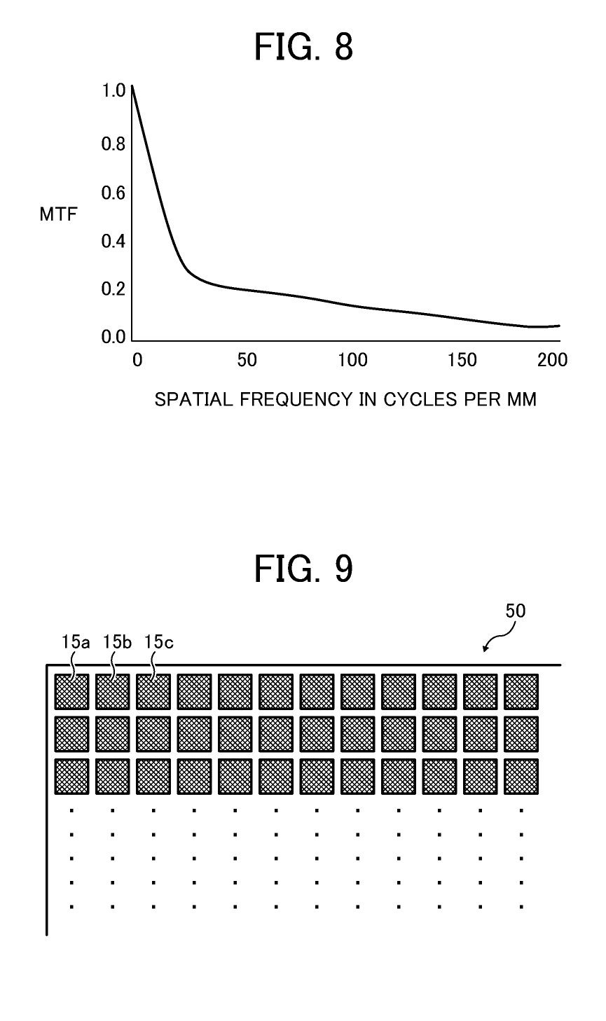

FIG. 8 illustrates an example of the change of MTF depending on the object distance of the imaging lens. When the object distance changes from 10 mm to ∞, the MTF does not substantially change and thus the change in MTF is too small to be graphically distinct in FIG. 8.

Thus, the OTF gain of the imaging lens is not so significantly affected by the change in the object distance. A possible reason thereof is because the lens diameter is relatively small. A smaller lens diameter reduces the light intensity, thus generally producing a relatively darker image.

However, for the above imaging lens, the F-number on the image surface IS is about 2.0, which is a sufficiently smaller value. Therefore, the imaging lens has sufficient brightness in spite of the smaller lens diameter.

The shorter the focal length of the lens system, the smaller the focused image of the object, thus the resolution of the image is decreased. In such a case, the image capturing apparatus 100 may employ a lens array including a plurality of imaging lenses.

Using the lens array, the image capturing apparatus 100 picks up single-eye images to form a compound-eye image. The image capturing apparatus 100 reconstructs a single object image from the single-eye images constituting the compound-eye image. Thereby, the image capturing apparatus 100 can provide the object image with sufficient resolution.

As described above, the lens thickness “t” and the back focus “b” are 0.4 mm and 0.8 mm, respectively. Therefore, the distance from the surface of the lens array 8a to the image surface IS becomes 1.2 mm. Thus, even when the thicknesses of the image pickup device, the image display, the reconstructing circuit, and the reconstructed-image correcting unit are considered, the image capturing apparatus 100 can be manufactured in a thinner dimension so as to have a thickness of a few millimeters.

Therefore, the image capturing apparatus 100 is applicable to electronic apparatuses, such as cellular phones, laptop computers, and mobile data terminals including PDAs (personal digital assistants), which are preferably provided with a thin built-in device.

As described above, a diffraction lens such as a hologram lens or a Fresnel lens may be used as the imaging lens. However, when the diffraction lens is used to capture a color image, the effect of chromatic aberration on the lens may need to be considered.

Hereinafter, a description is given to an image capturing apparatus 100 for capturing a color image according to another exemplary embodiment of the present invention.

In another exemplary embodiment, except for employing a color CCD camera 50 as the image pickup device 3, the image capturing apparatus 100 according to the present exemplary embodiment has substantially identical configurations to FIG. 1.

The color CCD camera 50 includes a plurality of pixels to pick up a focused image. The pixels are divided into three categories: red-color, green-color, blue-color pickup pixels. Corresponding color filters are located above the three types of pixels.

FIG. 9 is a schematic view illustrating an example of a pixel array of the color CCD camera 50.

As illustrated in FIG. 9, the color CCD camera 50 includes a red-color pickup pixel 15a for obtaining brightness data of red color, a green-color pickup pixel 15b for obtaining brightness data of green color, and a blue-color pickup pixel 15c for obtaining brightness data of blue color.

Color filters of red, green, and blue are disposed on the respective pixels 15a, 15b, and 15c, respectively, corresponding to the colors of brightness data to be acquired. On the surface of the color CCD camera 50, a set of the three pixels 15a, 15b, and 15c are sequentially disposed to obtain the brightness data of the respective colors.

On an image obtained by the red-color pickup pixel 15a, correcting computations may be executed to correct image degradation in the image based on the OTF data of red wavelengths. Thus, an image corrected for red color based on the OTF data can be obtained.

Similarly, on an image obtained by the green-color pickup pixel 15b, correcting computations may be executed to correct image degradation of the image based on the OTF data of green wavelengths. Further, on an image obtained by the blue-color pickup pixel 15c, correcting computations may be executed to correct image degradation of the image based on the OTF data of blue wavelengths.

For a color image picked up by the color CCD camera 50, the image capturing apparatus 100 may display the brightness data of respective color images on the pixels of an image display 6. The pixels of the image display 6 may be arranged in a similar manner to the pixels of the color CCD camera 50.

Alternatively, the image capturing apparatus 100 may synthesize brightness data of the respective colors in an identical position between a plurality of images. Then, the image capturing apparatus 100 may display the synthesized data on the corresponding pixels of the image display 6.

When the color filters are arranged in a different manner from FIG. 9, the image capturing apparatus 100 may separately execute the correcting computations on the brightness data of the respective color images. Then, the image capturing apparatus 100 may synthesize the corrected brightness data to output a reconstructed image.

Embodiments of the present invention may be conveniently implemented using a conventional general purpose digital computer programmed according to the teachings of the present specification, as will be apparent to those skilled in the computer art. Appropriate software coding can readily be prepared by skilled programmers based on the teachings of the present disclosure, as will be apparent to those skilled in the software art. Embodiments of the present invention may also be implemented by the preparation of application specific integrated circuits or by interconnecting an appropriate network of conventional component circuits, as will be readily apparent to those skilled in the art.

Numerous additional modifications and variations are possible in light of the above teachings. It is therefore to be understood that within the scope of the appended claims, the disclosure of this patent specification may be practiced in ways other than those specifically described herein.

1.-3. (canceled)

4. An image capturing apparatus, comprising:
a lens array including a plurality of imaging lenses, the lens array forming a compound-eye image including single-eye images of the object, the single-eye images being formed by the respective imaging lenses;
a reconstructing circuit to execute computations for reconstructing a single object image from the compound-eye image formed by the lens array; and
a reconstructing-image correcting circuit to execute computations for correcting image degradation of the single object image reconstructed by the reconstructing circuit.

5. The image capturing apparatus according to claim 4, wherein in executing the computations for reconstructing the single object image, the reconstructing circuit determines a relative position between the single-eye images based on a least square sum of brightness deviation between the single-eye images.

6. The image capturing apparatus according to claim 4,
wherein the reconstructed-image correcting circuit separately executes the correcting computations of image degradation for the respective single-eye images, and
wherein the reconstructing circuit executes the reconstructing computations of the single object image based on the single-eye images having been corrected by the reconstructed-image correcting circuit.

7. The image capturing apparatus according to claim 4, wherein the reconstructed-image correcting circuit executes the correcting computations of image degradation for the single object image having been reconstructed by the reconstructing circuit.

8. The image capturing apparatus according to claim 4, further comprising a light shielding member to suppress cross talk of light between the imaging lenses.

9.-14. (canceled)

15. An electronic apparatus comprising the image capturing apparatus according to claim 4.

16. (canceled)

17. A method of capturing an image with the image capturing apparatus according to claim 4, comprising the steps of:
forming a compound-eye image including single-eye images of an object;
executing computations for reconstructing a single object image from the compound-eye image; and
executing computations for correcting image degradation of the single object image.

18. A method of capturing an image with the image capturing apparatus according to claim 4, comprising the steps of:
forming a compound-eye image including single-eye images of an object being focused by the plurality of imaging lenses;
picking up the single-eye images;
reading optical transfer function data of at least one of the plurality of imaging lenses;
correcting image degradation of the single-eye images based on the optical transfer function data;
selecting a reference single-eye image from among the single-eye images;
detecting parallaxes between the reference single-eye image and each of the other single-eye images;
reconstructing a single object image based on the parallaxes; and
outputting the single object image.

19. A method of capturing an image with an image capturing apparatus, comprising the steps of:
forming a compound-eye image including single-eye images of an object being focused by a plurality of imaging lenses;
picking up the single-eye images;
reading optical transfer function data of at least one of the plurality of imaging lenses;
correcting image degradation of the single-eye images based on the optical transfer function data;
selecting a reference single-eye image from among the single-eye images;
detecting parallaxes between the reference single-eye image and each of the other single-eye images;
reconstructing a single object image based on the parallaxes; and
outputting the single object image.
